(19) United States
(12) Patent Application Publication
(10) Pub. No.: US 2016/0098781 A1
(43) Pub. Date: Apr. 7, 2016

(54) REAL TIME CHARGING MECHANISM FOR PURCHASING A PRODUCT

(71) Applicant: Sekhar Rao Balaga, Bangalore (IN)

(72) Inventor: Sekhar Rao Balaga, Bangalore (IN)

(21) Appl. No.: 14/876,630

(22) Filed: Oct. 6, 2015

(30) Foreign Application Priority Data
Oct. 7, 2014 (IN) 5026/CHE/2014

(51) Int. Cl. G06Q 30/06; G06Q 10/08

(52) U.S. Cl. CPC G06Q 30/0635; G06Q 10/083

(57) ABSTRACT

A method and system for charging a user in real time for purchasing a product through a communications device with or without data connection is provided. The method includes receiving a purchase request from the user of a user terminal, while the user is in the midst of using an application for which the user desires to purchase the product. The method includes sending the purchase request through a call dialing a special number by the user terminal for purchasing the product. The method includes receiving an explicit confirmation from the user for the purchase requests before initiating the charge deduction for the purchase requests. Further, the method includes deducting the charge for the purchase request in coordination with a network operator of the user and allowing the user to receive the requested product.

### TECHNICAL FIELD

This application claims the benefit of Indian Provisional Application No. 5026/CHE/2014, filed on Oct. 7, 2014. The embodiments disclosed herein relates to charging mechanism in telecommunication systems and more particularly to a mechanism of real time charging for purchasing a product through a communication device with or without a data connection.

### BACKGROUND OF INVENTION

The number of services provided by mobile network operators has considerably increased in the past few years. The convergence of mobile communication networks has enabled the creation of new value added services for mobile subscribers. Further, the proliferation of mobile communication device, such as mobile phone, “smart phone,” wirelessly connected tablets, and other such devices, offers an additional level of convenience for users desiring to purchase products such as virtual goods, coins, levels and other services online. When a user is using a communication device to initiate a purchase of the product, an electronic payment method is invoked where a credit card or debit card is been used to facilitate the purchase and deliver the product.

When the user selects a product for purchase, a purchase request from the user is redirected to a merchant associated with the product. The merchant requests the user to provide a confirmation for purchasing the requested product after generating a purchase receipt for the product. When the user provides the confirmation for the purchase, the merchant redirects the purchase request to a payment gateway for billing the requested product. The user inputs credentials and other associated security codes. The payment gateway processes the purchase request after obtaining credentials of the user and the payment gateway informs the merchant to deliver the requested product to the user after processing the purchase request.

In the above described system, the purchase request is processed through a data connection or Wireless-Fidelity (Wi-Fi) connection between the user terminal and the payment gateway. In the existing system, the merchant associated with the product may obtain the details of the communication device which may include a mobile number and other identification data related to the user, while redirecting the purchase request to the payment gateway or while obtaining the information from the payment gateway to deliver requested product to the user. Further, the merchant after obtaining the details of the communication device (through the payment gateway) may request the user of the communication device for availing various subscriptions related to the one or more services provided by the merchant without any consent of the user. Such kind of activity (generating unwanted alert messages to the user which may request the user for availing various subscriptions) by the merchant may cause inconvenience to the user.

In certain scenarios, problems may arise when the user does not have data connectivity on his/her communication device for purchasing the goods/service. Further, few users do not feel comfortable in making purchasing online. Furthermore, all of the online payment options do not provide a seamless purchase experience to the user, since the user has to undergo the online payment gateway process to complete the purchase. The existing systems do not provide charging mechanism for purchasing goods/services with or without data connection on the communication device.

Hence there is a need for a method and system that provides a seamless user experience for real time charging of the purchase requests originated from an application on the communication device with or without the data connection or the Wi-Fi connection.

### SUMMARY

Accordingly the embodiments herein provide a system. The system includes a user terminal, a plurality of network nodes, a server and a delivery server. The system is configured to send a purchase request associated with a product to the server through a call, by the user terminal. Further, the system is configured to obtain an explicit confirmation, by the server, from a user to purchase the product, upon informing charges associated with the product. Furthermore, the system is configured to initiate, by the server, a charging procedure with one or more network nodes.

Accordingly the embodiments herein provide a method for charging a user for purchasing a product. The method includes receiving a purchase request associated with a product from a user terminal through a call, by a server. The purchase request includes at least one parameter corresponding to the product and the user terminal. Further, the method includes obtaining an explicit confirmation, by the server, from a user to purchase the product, upon informing charges associated with the product. Furthermore, the method includes initiating, by the server, a charging procedure with the at least one network node.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1 illustrates a high level overview of the system for charging a user for purchasing a product through a user terminal, according to the embodiments as disclosed herein;

FIG. 2 illustrates an overview of a telecommunication network for charging a user, according to the embodiments as disclosed herein;

FIG. 3 illustrates a system for charging a user for purchasing the product, according to the embodiments as disclosed herein;

FIG. 4 is a flow diagram explaining the various steps involved in the method of charging a user in real time for purchasing the product, according to the embodiments as disclosed herein;

FIGS. 5A-5D illustrate sequence diagrams in which the purchase request from the user terminal is processed for, according to the embodiments as disclosed herein; and

FIGS. 6A and 6B illustrate block diagrams of a user terminal with various modules, according to embodiments as disclosed herein;

FIG. 7 illustrates an example scenario in which the charging is performed in real time for a purchase request initiated from a gaming application on the user terminal, according to the embodiments as disclosed herein;

FIG. 8 illustrates another example scenario in which the charging is performed in real time for a purchase request initiated from a WAP portal of a telecom network operator, according to the embodiments as disclosed herein; and

FIG. 9 illustrates a computing environment implementing a method and system of charging a user in real time for purchasing the product, according to the embodiments as disclosed herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

The embodiments herein achieve a method and system for charging a user in real time for purchasing a product through a user terminal Initially, the user of the user terminal selects the product for purchase. When the user selects the product and clicks on buy button, a purchase request is generated. The purchase request includes one or more parameters corresponding to the product and the user terminal 102. The one or more parameters include product ID, charge associated with the product (price point) and Mobile Station International Subscriber Directory Number (MSISDN) of the user terminal 102, International Mobile Equipment Identity (IMEI), International Mobile Subscriber Identity (IMSI), identification details of a merchant (merchant ID) and the like.

The method includes sending a purchase request associated with a product to a server through a call, by the user terminal.

In an embodiment, the user terminal dials a special number for purchasing the product. The method includes obtaining an explicit confirmation from the user to purchase the product upon informing charges associated with the product.

In an embodiment, the charges associated with the product are displayed on the user terminal 102 through short message service (SMS), Unstructured Supplementary Service Data (USSD), Voice over Internet Protocol (VoIP) call for receiving the explicit confirmation from the user. Further, the method includes initiating a charging procedure with one or more network nodes by the server and delivering the requested product to the user terminal.

The method includes acknowledging the charge confirmation by reading or answering the call/maturing the call from the user terminal/handheld by recognizing Dual Tone Multiple Frequency (DTMF) values sent or received from the server. The DTMF values can be sent between user terminals/handhelds/servers and vice versa in an invisible mode or in a visible mode by means of exchanging DTMF values across Social Networking Sites (SNSs), Instant messaging applications, Peer to Peer networks (P2P), Voice over Internet Protocol (VoIP) networks and so on.

In an embodiment, the user terminal acquires heat map events and logs, occurring in the application during the use of the application and collects all the events like pressing “buy” button and so on. The user terminal processes all the events and generates unique DTMF's. Further, the user terminal processes the DTMF digits and sends to the server or receives from the server on success/failure events respectively.

For a brief description of the real time charging mechanism, a reference is made to U.S. Pat. No. 8,781,440, entitled “A real time charging mechanism to deliver on demand telecommunication services”.

Unlike conventional system, the proposed method provides an enhanced user experience in purchasing the product, since the user can remain on current application, while the purchase request is being processed. Also, the conventional method of purchase is based on Internet Protocol (IP), SMS and USSD which may be prone to connection losses in processing the purchase request. In the proposed method, the purchase request is sent through a conventional telephony such as a voice/signal call from the application to the mobile network operator of the user. Furthermore, the method and system disclosed herein provides a real time charging for purchase requests from the user terminal with or without the data connection or the Wi-Fi connection.

Throughout the description, the terms Mobile Switching center (MSC) and Network node are used interchangeably.

Throughout the description, the term product refers to either tangible product or intangible product. The examples of the product can be either content, service, virtual goods, boosters, functionality and the like. It has to be understood that the above examples of the product are not limited thereto. Further, it should be noted that specific example of the product is chosen for describing the embodiments of the method and system.

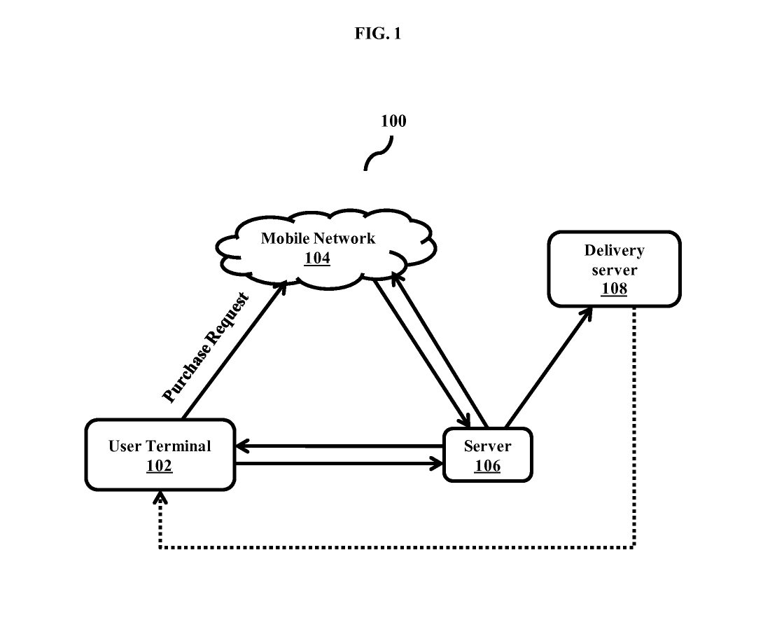

Referring now to the drawings and more particularly to FIGS. 1 through 9, where similar reference characters denote corresponding features consistently throughout the figures, there are shown preferred embodiments.

FIG. 1 illustrates a high level overview of a system 100 for charging a user for purchasing a product through a user terminal, according to the embodiments as disclosed herein. As depicted in the FIG. 1, the system 100 includes a user terminal 102, a mobile network 104, a server 106 and a delivery server 108.

The user terminal 102 may include, but are not limited to, a mobile phone, a tablet, a smart phone or any communication device.

The mobile network 104 is a public land mobile network (PLMN) which includes one or more components for providing communication. In general, the mobile network 104 can include a radio access network (RAN) and a core network. The RAN includes a plurality of base stations which are deployed at different locations. The RAN is connected to the core network which acts as a central entity with various components for providing telecommunication services.

The core network includes a home location register/Home subscription server, a mobile management entity (MME), a serving gateway (S-GW) and a packet data network (PDN) gateway and the like.

The server 106 is a third party server. In an embodiment, the server 106 can be network data center, a third party consent gateway or the like.

The server 106 receives the purchase request from the user terminal 102. Further, the server 106 processes the purchase request in coordination with the mobile network 104. In an embodiment, the server 106 can be present in the mobile network 104.

The delivery server 108 is a server that corresponds to a merchant associated with the product. The delivery server 108 delivers the requested product to the user terminal after receiving indication from the server 106.

The various steps involved in charging the user for purchasing the product is as described herein. Initially, the user terminal generates a purchase request for the product selected by the user.

The purchase request includes one or more parameters corresponding to the product and the user terminal 102. The one or more parameters include product ID, charge associated with the product (price point) and Mobile Station International Subscriber Directory Number (MSISDN) of the user terminal 102, IMEI, IMSI, identification details of a merchant (merchant ID) and the like.

In an embodiment, the user terminal 102 sends the purchase request to the mobile network 104 through a call. The user terminal 102 dials a special number to send the purchase request to the mobile network 104.

The mobile network 104 redirects the purchase request to the server 106. The server 106 plays announcement to the user for receiving explicit confirmation from the user terminal 102. The server 106 receives the confirmation from the user terminal. After receiving the explicit confirmation from the user of the user terminal 102, the server 106 processes the purchase request in coordination with the mobile network 104.

When the purchase request is processed by the server 106 the server 106 informs the delivery server 108 indicating that the purchase request is processed successfully. The delivery server 108 delivers the requested product to the user.

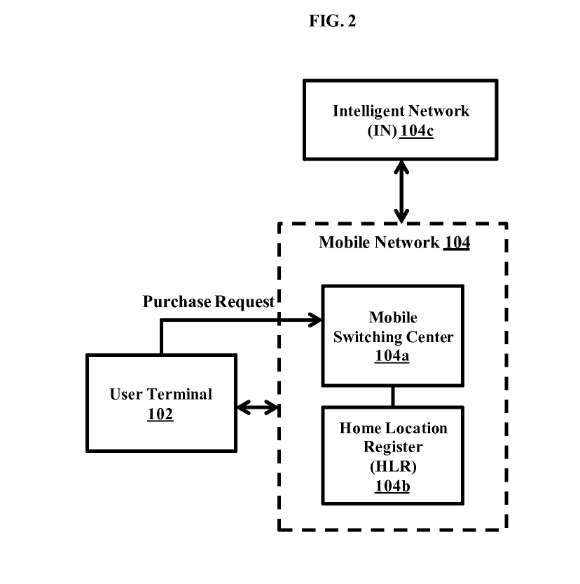

FIG. 2 illustrates an overview of a telecommunication network for charging a user, according to the embodiments as disclosed herein. The system as shown in FIG. 2 comprises a telecommunication network (a Mobile Network (MN) 104), which in this example is a mobile communication network (Public Land Mobile Network (PLMN)). The telecommunication network, MN 104 comprises Mobile Switching Center (MSC) 102a and a Home Location Register (HLR) 102b. It is understood to a person of ordinary skill in the art that the telecommunication network, mobile network 104 include other network components in addition to the components shown in FIG. 2.

The system also comprises a user terminal 102, for example, a mobile device. The user terminals are connected to the telecommunication network MN 104 through a radio interface. Further, the telecommunication network MN 104 is connected to an Intelligent Network (IN) 104c as shown in the figure.

The IN 104c is a network architecture which can be incorporated in the network, that makes implementation and controlling of services faster, easier and more flexible and can be achieved by moving the service control out from the switching exchange into a separate functional unit of the intelligent network. In addition to the actual network operator, the IN 104c may include several service providers.

According to the embodiments disclosed herein, with reference to FIG. 2, a user of the user terminal 102 can purchase a product/service/content through an application running on the user terminal 102 with or without the data connection or the Wi-Fi connection. The user can select a desired product through the application. When the user selects the product, in the application (which is running on the user terminal 102), the user terminal 102 dials a special number, through which a purchase request is sent to the mobile switching center 102a as shown in the FIG. 2.

The purchase request is processed at the MSC 102a in coordination with a charging server (not shown in the figure and is described in the later parts of the description) after obtaining an explicit confirmation from the user for deducting the appropriate charge for the selected product/service.

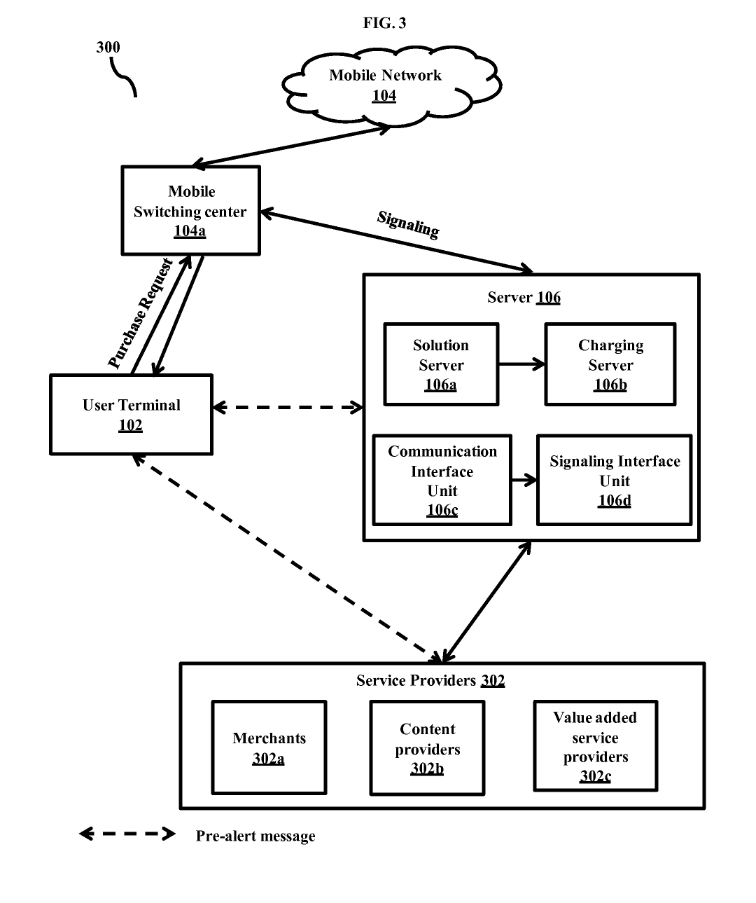

FIG. 3 illustrates a high level architecture of a system 300 for charging a user in real time for service/content/product requests originated from various applications on communications devices, according to the embodiments as disclosed herein. As depicted in FIG. 3, the system 300 includes a user terminal 102, a mobile switching center or Network node 104a, a server 106, a mobile network 104 and service providers 302 connected to the server 106. The mobile network 104 may be a wired telephony network, a wireless network, a voice call network, a signaling system number 7 (SS7) network, an internet protocol (IP) network, and other data networks and so on.

Further, in FIG. 3, the service providers 302 may include, but are not limited to merchants 302a, content providers 302b, value added service providers 302c connected to the server 106 through the mobile network 104. The charging server 106b present within the server 106 acts as a central entity that integrates with a variety of service providers 302 for delivering on-demand purchases to the users.

The server 106 includes a solution server 106a, a charging server 106b, a communication interface unit 106c and a signaling interface unit 106d. The solution server unit 106a receives the purchase request from the mobile switching center 104a of the user. The solution server 106a plays an announcement to the user related to purchase request and the charge associated with the purchase request. The solution server module 106a requests explicit confirmation from the user for processing the purchase request. Upon the confirmation from user, the solution server 106a redirects the service charging request to the charging server 106b.

The charging server 106b receives the charging request from the solution server 106a and makes a special charge call with signaling that comprises the mobile number of the user and a charge number to the mobile switching center 102 of the user.

In an embodiment, the charging server 106b makes a special charge call through IP to different network nodes of the operator. For example, the network nodes may include a Service Delivery Platform (SDP), an Intelligent Network (IN), a prepaid platform or the like. The charging server 106b processes the service charging request in coordination with the mobile switching center 102 for charge deduction.

The communication interface unit 106c communicates with the network operators through signaling using a variety of protocols. In an embodiment, the server 106 communicates through the communication interface unit 106c using the ISDN user part ISUP protocol.

The signaling interface unit 106d facilitates the server 106 to achieve signaling communication with the network operators. In an embodiment, the server 106 may be connected to multiple network operators/wallet service provides/any service providers for providing payment services.

The method of charging the user in real time for purchasing the product through the user terminal 102 is as described herein.

Initially, the user of a user terminal 102 selects the product (a service/content) to purchase through the application running on the user terminal 102.

In an example, when the user opens a gaming application on the user terminal 102, for example, in a gaming application, a game is free for a limited time, and then requires a purchase, or the user might have to purchase additional game levels or the user might have to purchase full functionality of a game. Similarly, in a content application, the user can choose to purchase and download newsletters, wallpapers and so on. In this scenario, the user selects an item (which can be service/product/content) of his/her choice and decides to purchase the selected item on the application. When the user clicks (for example, on a purchase button or buy button displayed on the application as an interface), in an embodiment, the user terminal 102 sends an indication (for example through an SMS/HTTP/IP/DTMF) to the server 106 and the corresponding server, (for example an application server or delivery server 108) associated with the service provider of the application. In an example, if the user is running a gaming application on the user terminal 102 and if the user requests for a purchase through the gaming application, then the user terminal 102 sends the indication through the SMS/HTTP/IP/DTMF to the server 106 and the gaming application server 108. In an embodiment, an automated DTMF can be created, which may include digits that indicate the application (gaming application) running in the user terminal 102 to the server 106. In an example, the server 106 identifies the details of the gaming application running on the user terminal 102. The server 106 may be prepared in advance for receiving the purchase request from the gaming application by obtaining the details of the application through the automated DTMF through the application. The DTMF may include codes or numbers for indicating the details of the application running on the user terminal 102 to the server 106. In an embodiment, the user terminal 102 acquires heat map events and logs occurring in the application during the use of the application and collects all the events like pressing “buy” button and so on. The user terminal processes all the events and generates unique DTMF's. Further, the user terminal processes the DTMF digits and sends to the server 106 or receives from the server on success/failure events.

In an embodiment, the indication notifies the server 106 and the delivery server that the user is interested in purchasing a product/service through the gaming application on the user terminal 102.

In an embodiment, the indication can be sent through an Internet Protocol (IP) connection to the server 106 and the corresponding server of the application running on the user terminal 102.

Further, the user can send the purchase request for purchasing through the application by providing a call or a buy option as an interface, which is displayed to the user on the application. When the user clicks on the call or buy option (which is provided to the user through an Application Programming Interface (API)), the user terminal 102 dials a special number and the purchase request initiated by the user is redirected to the server 106 through the mobile switching center 104a. In an embodiment, the user terminal 102 dials a Voice over Internet Protocol (VoIP) call, when the user terminal has the Wi-Fi connection and the purchase request is redirected to the server 106.

In an embodiment, the user may or may not be charged for dialing the special number for initiating the purchase request.

The server 106 receives the purchase request from the user terminal 102 and allows the solution server 106a to play an announcement to the user regarding the purchase and the charge associated with the purchase request.

In an embodiment, the solution server 106a requests the user to provide an explicit confirmation or consent for the purchase by announcing the purchase request and the charge associated with the purchase request. For example, the solution server 106a announces the purchase request and allows the user to input a unique number for purchasing the product through the application. In an embodiment, the user terminal 102 opens up a dialer for the user, where the user provides a corresponding input, as announced by the solution server 106a to confirm the purchase request.

In an embodiment, the solution server 106a requests for a consent from the user for the purchase by pressing DTMF tones, through Voice input (Biometric), USSD, One time Password (OTP), SMS, Internet Protocol (IP) and so on. In an embodiment, the user may create his/her own Personal Identification Number (PIN) for providing the confirmation to the purchase request. Further, the user may be provided with a default PIN for confirming the purchase request.

In an embodiment, the solution server 106a requests the consent from the user by playing an announcement for the user to enter the Personal Identification Number (PIN) to confirm the purchase request. For example, when the user is identified as a frequent user (the frequent user is the user who avails the service/content frequently), the solution server 106a plays announcement to the frequent user to enter the PIN to confirm the purchase request. In an embodiment, the frequent user may create his/her own PIN, which is required for providing the confirmation to the purchase request. In an embodiment, a default PIN may be provided to the user for confirming the purchase request

When the solution server 106a receives the confirmation from the user for the purchase request, the solution server 106a sends a service charging request to the charging server 106b. Further, the charging server 106b makes a special charge call with signaling that comprises mobile number of the user and the charge number to the mobile switching center 102a through ISDN User Part (ISUP) protocol/Wireless Application Protocol (WAP)/Internet Protocol (IP). The mobile switching center 102a identifies mobile number of the user and the charge number that is present within the signaling message and processes the charging request in coordination with the charging server 106b.

The mobile switching center 104a (of the user) deducts the balance according to the type of the subscriber using the standard charging mechanism for prepaid and post paid subscribers.

In an embodiment, the charging server 106b may be able to authenticate the user of the user terminal 102 before performing charge deduction. The charging for providing the desired purchase (as requested by the user) involves verifying the credentials of the user with the help of HLR 104b which exists within the network 104. Further, the server 106 acts as a communication platform that communicates with the network operators or mobile switching centers for performing the charge deduction.

In an embodiment the server 106 may use a suitable communication protocol such as ISUP protocol/WAP/IP to communicate with MSCs of the user terminal.

When the charge deduction is completed, the solution server 106a communicates the charge deduction to the server (for example, an application server or delivery server 108) associated with the application running on the user terminal 102. In an example, when the user sends a purchase request through the gaming application, upon completion of the charge deduction, the solution server communicates the charge deduction to the gaming server through WAP/IP. The gaming server provides the requested item to the user. In an embodiment, the gaming server sends a SMS to the user, which can be readable by the application on the user terminal 102. In an example, the SMS may allow the user to progress to a different level (if the user has requested to purchase a next level on the gaming application). In another example, the gaming server may deliver the requested service to the user (if the user has requested to purchase the service).

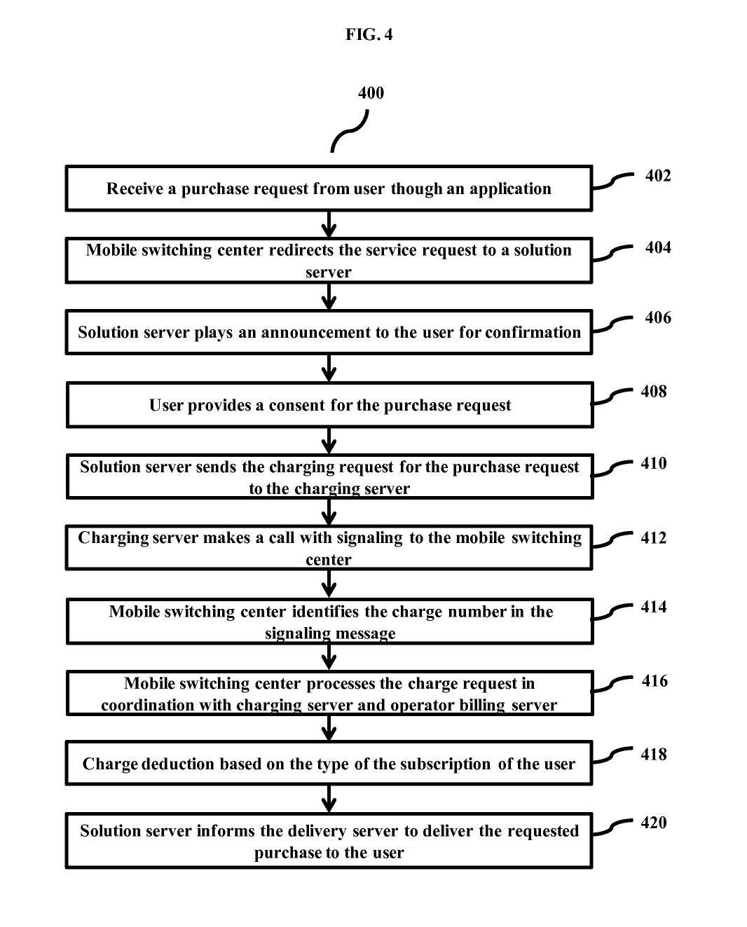

FIG. 4 is a flow diagram explaining the method 400 for charging the user in real time for service/purchase requests originated from various applications on communications devices, according to the embodiments as disclosed herein. Initially, the user requests for a purchase or a service through an application installed on the user terminal 102. This request reaches mobile switching center 104a) or network node of the service provider. The mobile switching center 104a receives (402) the purchase request from the user through the application running on the user terminal 102. Further, the mobile switching center 104a or the network node of the user redirects (404) the request to the solution server 106a. The solution server 106a plays (406) the announcement to the user regarding the purchase request and the charge associated with the purchase request. In an example, the solution server 106a announces the purchase request and allows the user to input a unique number for purchasing the service through the application. In an embodiment, the user may create his/her own Personal Identification Number (PIN) for providing the confirmation to the purchase request. Further, the user may be provided with a default PIN for confirming the purchase request.

In an embodiment, the solution server 106a requests the consent from the user by playing an announcement for the user to enter a Personal Identification Number (PIN) to confirm the purchase request, when the user is identified as the frequent user (the frequent user is the user who avails the service/content frequently) at the server 106.

The user provides (408) the consent to avail the requested purchase by inputting the unique number which is associated with the purchase. In an embodiment, the user provides the confirmation to the requested purchase by pressing DTMF inputs through Voice Input (Biometric), USSD, One Time Password (OTP) SMS, Internet Protocol (IP) and so on. In an embodiment, the frequent user may provide the created PIN to confirm the purchase request, in response to the announcement from the solution server 106a.

The solution server 106a receives the confirmation from the user for the requested purchase and the solution server 106a sends (410) the charging request for the purchase request to the charging server 106b. Further, the charging server 106b makes (412) a special charge call with signaling that comprises the mobile number of the user and a charge number to the mobile switching center 102 of the user. In an embodiment, the charging server 106b makes a special charge call through IP to different network nodes of the operator.

The mobile switching center 102 identifies (414) the charge number that is present within the signaling message and processes (416) the charging request in coordination with charging server 106b and the network operator billing server.

The mobile switching center 102 of the user charges (418) according to the type of the subscriber using the standard charging mechanism for prepaid and post paid subscribers.

The solution server 106a informs (420) the delivery server to deliver the requested purchase to the user. The various actions in method 400 may be performed in the order presented, in a different order or simultaneously. Further, in some embodiments, some actions listed in FIG. 4 may be omitted.

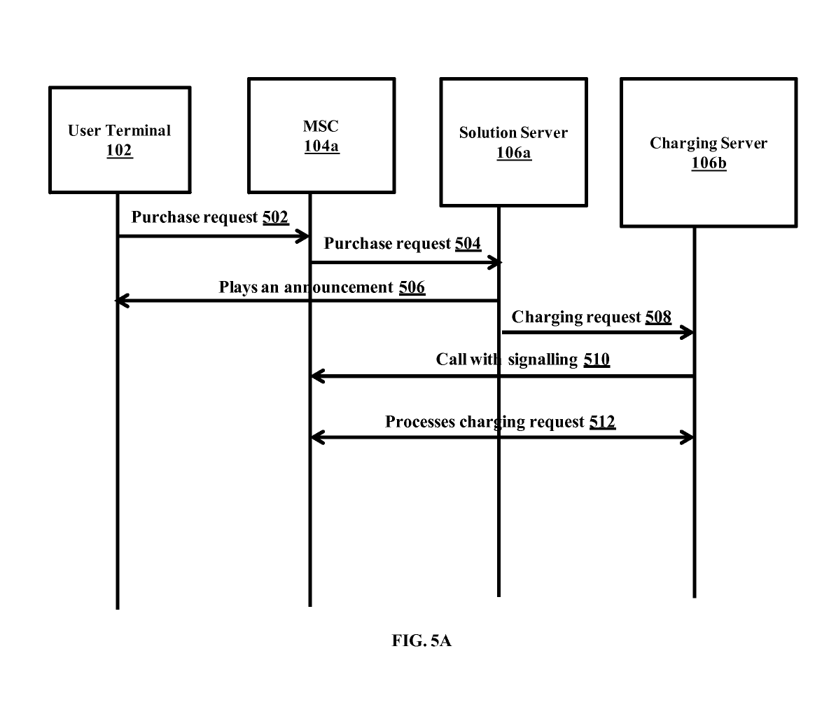

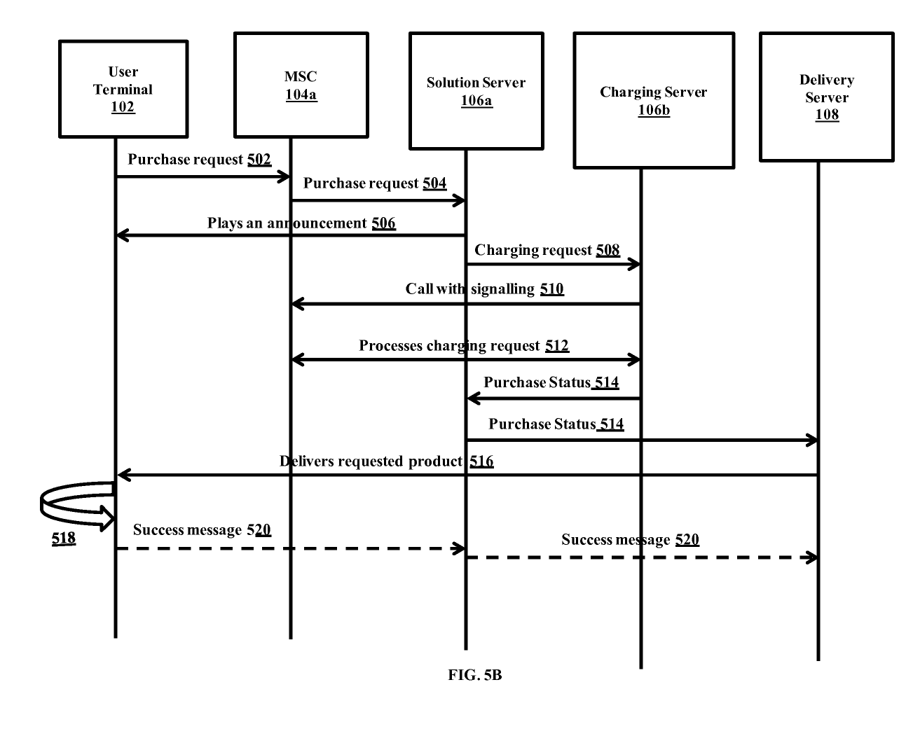

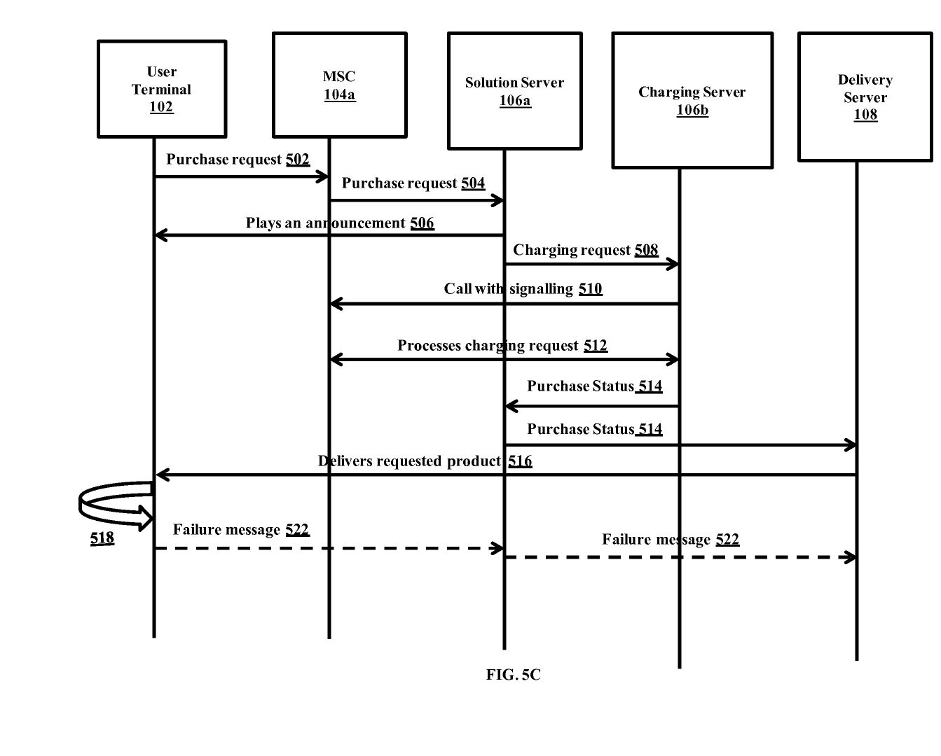

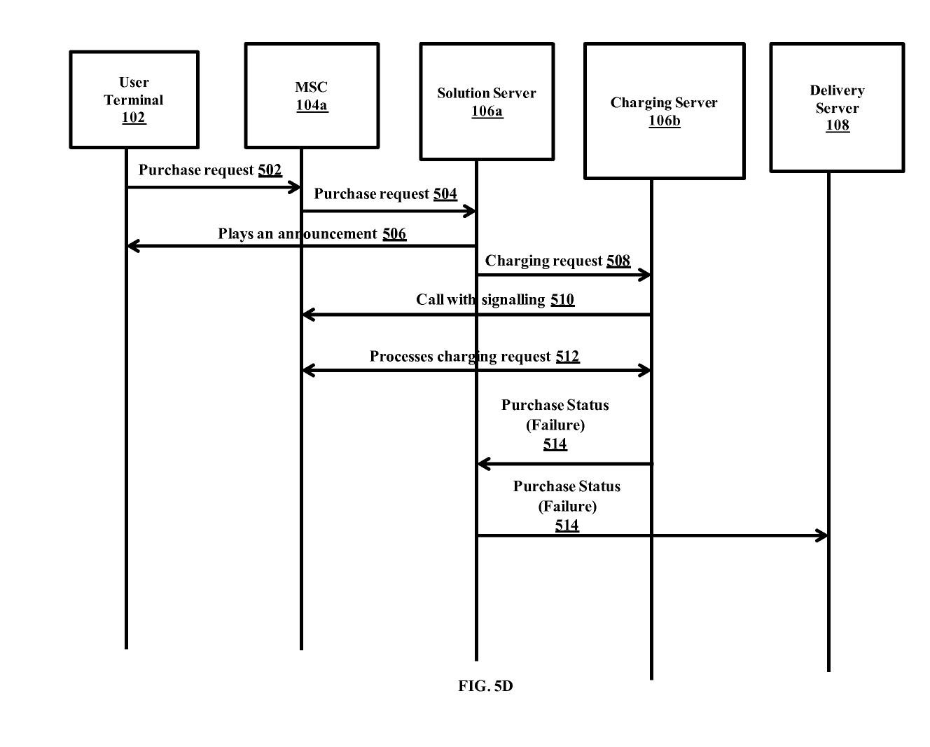

FIGS. 5A-5D illustrate sequence diagrams in which the purchase request from the user terminal is processed, according to the embodiments as disclosed herein.

As depicted in the sequence diagram in FIG. 5A, initially, the user terminal 102 sends (502) a purchase or a service request through an application installed on the user terminal 102 to the MSC 104a or network node of the service provider. The mobile switching center 102a receives the purchase request from the user terminal 102 and redirects (704) the purchase request to the solution server 106a. The solution server 106a plays (706) an announcement to the user regarding the purchase request and the charge associated with the purchase request. In an example, the solution server 106a announces the purchase request and allows the user to input a unique number for purchasing the service through the application.

In an embodiment, the user is requested to provide a confirmation to avail the requested purchase by inputting the unique number which is associated with the purchase. In an embodiment, the user provides the confirmation to the requested purchase by pressing DTMF inputs through Voice Input (Biometric), USSD, One Time Password (OTP) SMS, Internet Protocol (IP) and so on. In an embodiment, the user may create his/her own Personal Identification Number (PIN) for providing the confirmation to the purchase request. Further, the user may be provided with a default PIN for confirming the purchase request.

In an embodiment, the solution server 106a requests the consent from the user by playing an announcement for the user to enter the PIN to confirm the purchase request. For example, when the user is identified as a frequent user (the frequent user is the user who avails the service/content frequently), the solution server 106a plays announcement to the frequent user to enter the PIN to confirm the purchase request. In an embodiment, the frequent user may create his/her own PIN, which is required for providing the confirmation to the purchase request. In an embodiment, a default PIN may be provided to the user for confirming the purchase request.

The solution server 106a, upon receiving the confirmation from the user, sends (708) the charging request for the purchase request to the charging server 106b. Further, the charging server 106b makes (710) a special charge call with signaling that comprises the mobile number of the user and a charge number to the mobile switching center 104a of the user.

The mobile switching center 104a identifies the charge number that is present within the signaling message and processes (712) the charging request in coordination with charging server 106b and the network operator billing server.

The mobile switching center 104a charges the user according to the type of the subscriber using the standard charging mechanism for prepaid and post paid subscribers.

As depicted in the FIG. 5B, after processing the purchase request, the charging server 106b sends (514) a purchase status message to the solution server 106a. The purchase status message indicates whether the purchase request is processed successfully. The purchase status message includes the status (either success or failure) that indicates charging of the user for the purchase request.

In an embodiment, the purchase status message is sent to the solution server 106a from the charging server 106b by reversing the DTMF.

Further, the solution server 106a sends (514) the purchase status message to delivery server 108. If the purchase status message indicates that the purchase request is processed successfully, then the delivery server 800 delivers (516) the requested product to the user.

The user terminal 102 performs (518) one or more actions for executing the product received from the delivery server 108. In case, when the execution of the product is successful, the user terminal 102 sends (520) success message to the solution server 106b. Further, the solution server 106b sends (520) the success message to the delivery server 108.

In case, when the user terminal 102 fails (518) to execute the product received from the delivery server 108, then the user terminal sends (522) a failure message to the delivery server as depicted in the FIG. 5C. Further, the solution server 106b sends (522) the failure message to the delivery server 108.

Furthermore, if the purchase request is not processed successfully at the charging server 106b, then the solution server 106a sends (514) the purchase status as failure to the user terminal 102 as depicted in the FIG. 5D. Further, solution server 106a sends (514) the purchase status as failure to the delivery server 108.

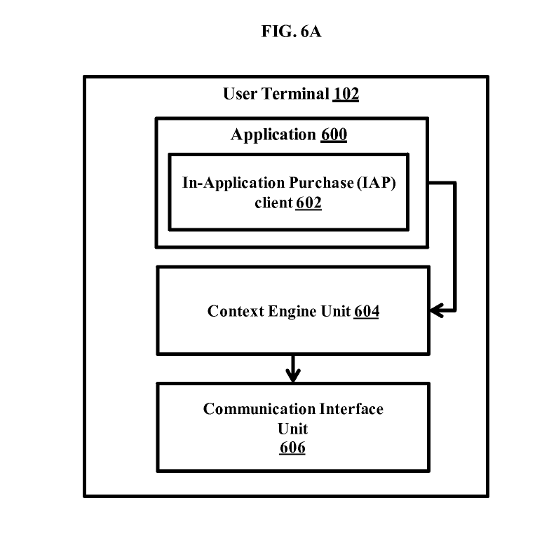

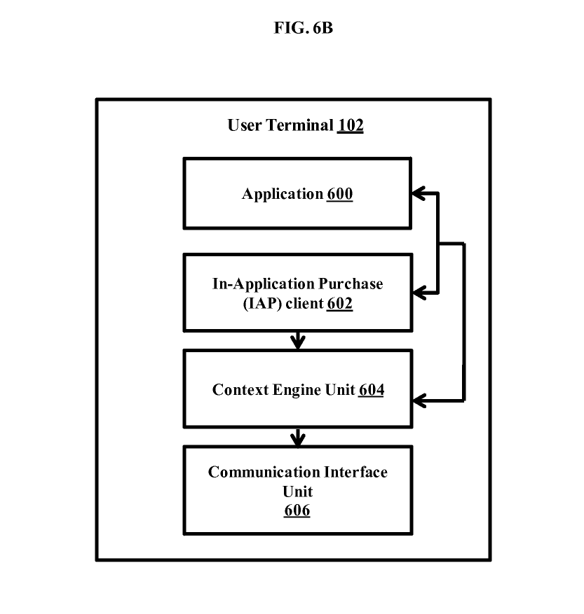

FIGS. 6A and 6B illustrate a block diagram of the user terminal with various modules, according to embodiments as disclosed herein. As depicted in the FIG. 6A, the user terminal 102 includes, an application 600, an In-Application Purchase (IAP) client 602, a context engine module 604 and a communication interface module 606.

The application 600 is a client for at least one of the services accessible to the user terminal 102. The term application 600, as used herein, refers to a process, typically implemented in software which operates on the user terminal 102. In an embodiment, the application 600 may communicate with the application service or a subscription service during operation of the application. Thus, the application 600 refers to a stand-alone process on the user terminal 102 or a client process on the user terminal 102 interacting with an unpaid service or a subscription service. The communication interface module 102c allows the user terminal 102 to connect to the mobile network 104.

The IAP client 602 can communicate with an IAP service (not shown in figure) for identifying items associated with the application that can be purchased, to indicate an item to be purchased, and to execute payment such that the item can be delivered to the application 600 on the user terminal 102. In an example, the IAP client 602 is a widget that can be embedded as an Application Programming Interface (API) within the application 600.

In an embodiment, the IAP client 602 generates the purchase request when the user selects the product and clicks on the “BUY” button to purchase product.

The context engine module 604 determines the local context of the user terminal 102, such as local time, geographic position from a positioning system, applications currently running on the user terminal 102, content currently being rendered on the user terminal 102, and user input through a user interface (UI).

The user terminal 102 is identified with an identifier (user terminal ID), such as an International Mobile Equipment Identity (IMEI) which is a unique number, to identify GSM, WCDMA, and some satellite mobile phones. An operator gateway (not shown in figure) often provides billing services for one or more subscription services.

The operator gateway is connected to an operator billing service, either directly, as depicted, or indirectly through the network to initiate payment from a consumer for use of the network and for use of any services that use operator billing. The mechanism of billing and other functions of operator gateway are accessed through the operator gateway API.

In an embodiment, the communication interface module 606 can be configured to send the purchase request to the MSC 104a.

In an embodiment, the IAP client 602 can be present outside the application 600 as shown in FIG. 6B. Further, in the FIG. 6B, when the IAP client 602 is present outside the application 600, the IAP client 602 can interface with a different application on the user terminal 102 other than the application 600. In an example, the IAP client 602 is a widget that can be present outside the application 200. In such case, the IAP client 602 can communicate with the IAP service (not shown in FIG. 6B) for identifying items associated with the application 600 that can be purchased.

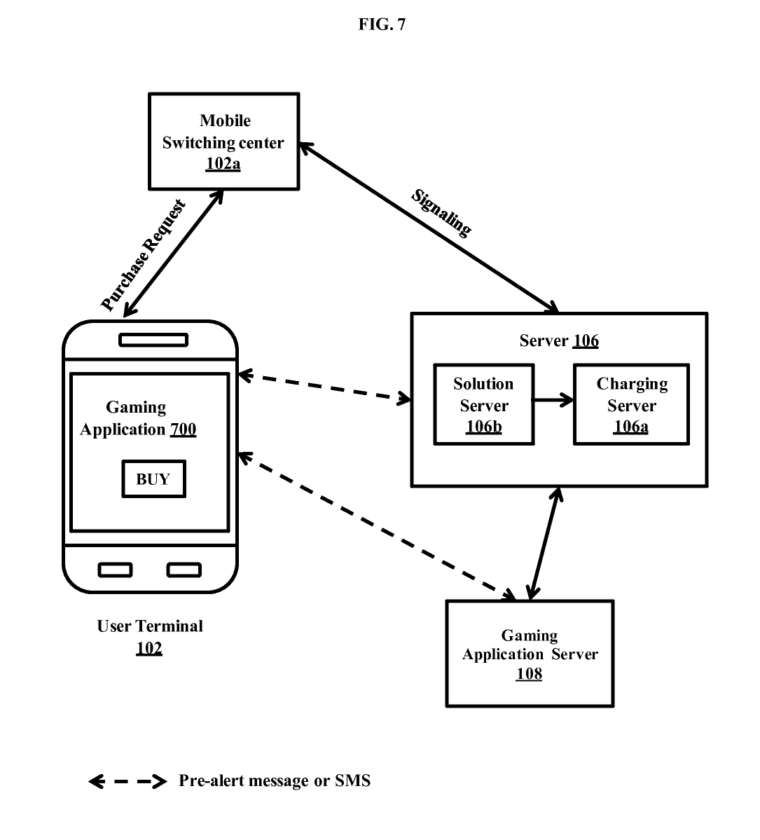

FIG. 7 illustrates an example scenario in which the charging is performed in real time for a purchase request initiated by the user through a gaming application on the user terminal 102, according to the embodiments as disclosed herein. In the example shown in the FIG. 7, the delivery server 108 is a gaming application server. As depicted in FIG. 7, the user of a user terminal 102 intends to purchase a product or a service through the gaming application running on the user terminal 102. The user of the user terminal 102 selects a desired product or a service and clicks to buy the selected product or service. When the user clicks on the interface “buy” as provided by the gaming application 800, the user terminal 102 initiates a call to the mobile switching center 104a of the user. The mobile switching center 104a receives the purchase request through the call from the user and redirects the call to the server 106. The solution server 106a receives the call and plays an announcement to the user for the purchase request and the charges associated with the purchase request. Further, the solution server 106a requests the user to confirm the purchase by announcing the purchase request and the charge associated with the purchase request. For example, the solution server 106a announces the purchase request and allows the user to input a unique number for purchasing the service through the application.

The solution server 106a receives the confirmation from the user for the purchase request and the solution server 106a sends a service charging request to the charging server 106b. Further, the charging server 106b makes the special charge call with signaling that comprises the mobile number of the user and the charge number to the mobile switching center 102a through ISDN User Part (ISUP) protocol. The mobile switching center 102a identifies mobile number of the user and the charge number that is present within the signaling message and processes the charging request in coordination with the charging server 106b.

The mobile switching center 102a (of the user) deducts the balance according to the type of the subscriber using the standard charging mechanism for prepaid and post paid subscribers.

When the charge deduction is completed, the solution server 106a communicates the charge deduction to the server associated with the application running on the user terminal 102. For example, when the user sends a purchase request through the gaming application, upon completion of the charge deduction, the solution server 106a communicates the charge deduction to the gaming application server 801. The gaming application server 108 provides the requested product or service to the user. In an embodiment, the gaming application server 801 sends the SMS to the user, which can be readable by the application on the user terminal 102. In an example, the SMS may allow the user to progress to a different level (if the user has requested to purchase a next level on the gaming application).

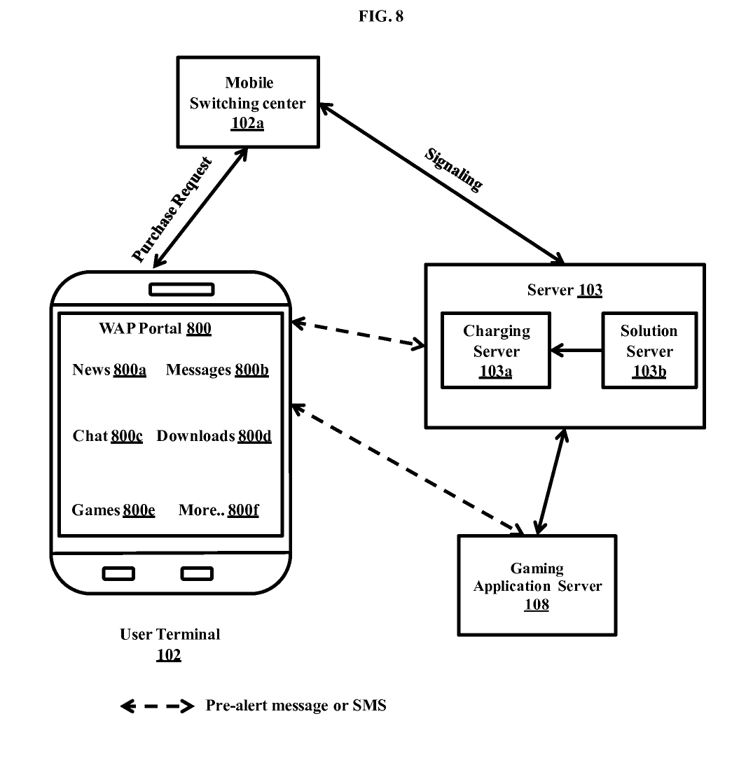

FIG. 8 illustrates a schematic of a WAP portal 800 of a telecom network operator, according to the embodiments as disclosed herein. The WAP portal 800 can be accessible to the user through a WAP browser (for example: a web browser for the user terminal 102) in the user terminal 102. In the FIG. 8, the WAP portal 800 displays icons namely news 800a, messages 800b, chat 800c, download 800d, games 800e and more 800f are shown. For example, if the user selects the games 800e icon, the games provided by the mobile network 104 (telecom network operator) are displayed to the user. The user may select any of the games to purchase. When the user clicks on the “buy” button, the user terminal 102 dials the special number for purchasing the game. The purchase request of the user for purchasing the game is processed at the server 106 and after completion of the charge deduction for purchasing the game, the server 106 informs the mobile network 104 to provide the requested game to the user.

In another example, the user may launch an online game through a web browser in the user terminal 102. While the user in midst of the game, the user may request for a service or additional functionality. In such case, the IAP client 102b which may be present within the game or outside the game with an IAP service (not shown in figure). The user can select any of the service or the additional functionality provided by the game. When the user clicks on the “buy” button for purchasing the service or the additional functionality, the user terminal 102 dials the special number for purchasing the game. The purchase request of the user for purchasing the game is processed at the server 106 and after completion of the charging procedure, the server 106 informs the delivery server 108 (providing the game) to deliver the requested service or additional functionality to the user.

Thus, the user requests the additional functionality/content/service by launching the game through the WAP portal 300 using the WAP browser on the user terminal 102 with the data connection or the Wi-Fi connection.

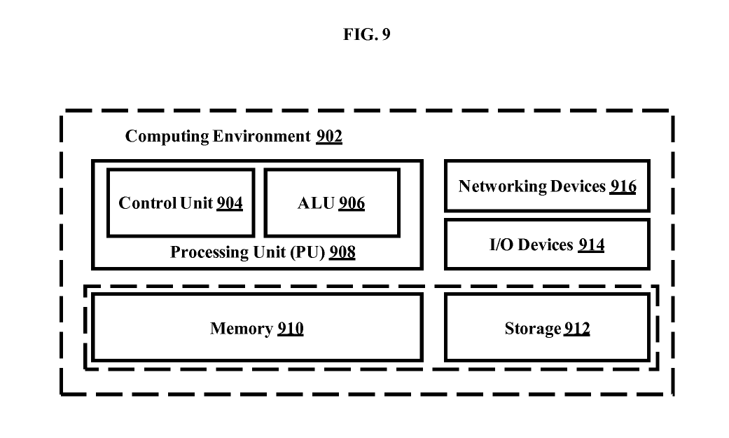

FIG. 9 illustrates a computing environment implementing a method and system of charging a user in real time for purchasing the product, according to the embodiments as disclosed herein.

As depicted the computing environment 902 comprises at least one processing unit 908 that is equipped with a control unit 904 and an Arithmetic Logic Unit (ALU) 906, a memory 910, a storage unit 912, plurality of networking devices 916 and a plurality Input output (I/O) devices 914. The processing unit 908 is responsible for processing the instructions of the algorithm. The processing unit 908 receives commands from the control unit in order to perform its processing. Further, any logical and arithmetic operations involved in the execution of the instructions are computed with the help of the ALU 906.

The overall computing environment 902 can be composed of multiple homogeneous and/or heterogeneous cores, multiple CPUs of different kinds, special media and other accelerators. The processing unit 904 is responsible for processing the instructions of the algorithm. Further, the plurality of processing units 904 may be located on a single chip or over multiple chips.

The algorithm comprising of instructions and codes required for the implementation are stored in either the memory unit 910 or the storage 912 or both. At the time of execution, the instructions may be fetched from the corresponding memory 910 and/or storage 912, and executed by the processing unit 908.

In case of any hardware implementations various networking devices 916 or external I/O devices 914 may be connected to the computing environment to support the implementation through the networking unit and the I/O device unit.

The embodiments disclosed herein can be implemented through at least one software program running on at least one hardware device and performing network management functions to control the elements. The elements shown in FIGS. 1 through 9 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

I claim:

1. A system comprising:
a user terminal, a plurality of network nodes, a server and a delivery server, wherein said system is configured to:
send a purchase request associated with a product to said server through a call, by said user terminal, wherein said purchase request includes at least one parameter corresponding to said product and said user terminal;
obtain an explicit confirmation, by said server, from a user to purchase said product, upon informing charges associated with said product; and
initiate, by said server, a charging procedure with at least one said network node.

2. The system of claim 1, wherein said server initiates said charging procedure with at least one said network node by:
initiating a call with signaling to a network node; and
coordinating with said network node to process said purchase.

3. The system of claim 1, wherein said purchase request associated with said product is sent to said server through a call, by said user terminal by:
detecting an event indicating purchase of said product from said user of said user terminal;
generating said purchase request associated with said product.

4. The system of claim 1, wherein said purchase request through said call is sent in one of: short message service (SMS), Hypertext Transfer Protocol (HTTP) request, Internet Protocol (IP), Dual Tone Multiple Frequency (DTMF), Unstructured Supplementary Services Data (USSD), Session Initiation Protocol (SIP), Voice Over Internet Protocol (VoIP) and Peer-to-Peer (P2P) network.

5. The system of claim 1, wherein said network node is one of: a mobile switching center and an interface, wherein said interface is one of: Global System for Mobile communication Association (GSMA) One Application Programming Interface (one API), Hyper Text Transfer Protocol (HTTP), Internet Protocol (IP), Voice Extensible Markup Language (VXML), Call Control XML (CCXML), User Communication Integration Protocol (UCIP), Telecom Web Services Server (TWSS), Third Party Consent Gateways (TPCGs) and Service Delivery Platform (SDP), charging gateways, financial services, mobile payment gateway, online banking, online wallet, mobile wallet and cash cards.

6. The system of claim 4, wherein said server sends a purchase status message to said delivery server by reversing said DTMF.

7. A method for charging a user for purchasing a product, the method comprising:
receiving a purchase request associated with a product from a user terminal through a call, by a server, wherein said purchase request includes at least one parameter corresponding to said product and said user terminal;
obtaining an explicit confirmation, by said server, from a user to purchase said product, upon informing charges associated with said product; and
initiating, by said server, a charging procedure with at least one said network node.

8. The method of claim 7, wherein initiating by said server, said charging procedure with at least one said network node comprises:
initiating a call with signaling to a network node; and
coordinating with said network node to process said purchase.

9. The method of claim 7, wherein receiving said purchase request associated with said product by said server comprises:
detecting an event indicating purchase of said product from said user of said user terminal; and
generating said purchase request associated with said product.

10. The method of claim 7, wherein said purchase request through said call is received in one of: short message service (SMS), Hypertext Transfer Protocol (HTTP) request, Internet Protocol (IP), Dual Tone Multiple Frequency (DTMF), Unstructured Supplementary Services Data (USSD), Session Initiation Protocol (SIP), Voice Over Internet Protocol (VoIP) and Peer-to-Peer (P2P) network.

11. The method of claim 7, wherein said network node is one of: a mobile switching center and an interface, wherein said interface is one of: Global System for Mobile communication Association (GSMA) One Application Programming Interface (one API), Hyper Text Transfer Protocol (HTTP), Internet Protocol (IP), Voice Extensible Markup Language (VXML), Call Control XML (CCXML), User Communication Integration Protocol (UCIP), Telecom Web Services Server (TWSS), Third Party Consent Gateways (TPCGs) and Service Delivery Platform (SDP), charging gateways, financial services, mobile payment gateway, online banking, online wallet, mobile wallet and cash cards.

12. The method of claim 10, wherein said method comprises sending a purchase status message to a delivery server by reversing said DTMF.
